(19) United States
(12) Patent Application Publication
(10) Pub. No.: US 2012/0251779 A1
(43) Pub. Date: Oct. 4, 2012

(54) HOUSING FOR ELECTRONIC DEVICE AND METHOD FOR MAKING SAME

(75) Inventors: WEI LIU, Shenzhen City (CN); SONG ZHANG, Shenzhen City (CN); MING-MING CHEN, Shenzhen City (CN)

(73) Assignees: FIH (HONG KONG) LIMITED, Kowloon (HK); SHENZHEN FUTAIHONG PRECISION INDUSTRY CO., LTD., ShenZhen City (CN)

(21) Appl. No.: 13/226,649

(22) Filed: Sep. 7, 2011

(30) Foreign Application Priority Data
Mar. 31, 2011 (CN) 201110080427.3

(51) Int. Cl. B32B 3/00; B23K 26/06; B05D 3/06; B23K 26/38

(52) U.S. Cl. 428/156; 219/121.69; 219/121.73; 219/121.8; 427/554

(57) ABSTRACT

A housing for an electronic device is described. The housing includes a metal substrate, and a plurality of recesses formed on an outer surface of the metal substrate. The recesses define a pattern. The recesses are dispersed on the outer surface with a gradual change of density of the recesses across at least one dimension of the outer surface. The recesses have an average width of about 0.02 mm-0.04 mm. The average depth of the recesses is about 0.05 mm-0.1 mm, and the distance between each two adjacent recesses is about 0.2 mm-2 mm.

### BACKGROUND

1. Technical Field

The present disclosure generally relates to a housing for electronic devices and a method for making the housing.

2. Description of Related Art

Housings for electronic devices having decorative patterns can be more appealing to consumers. Typically, patterns are formed by anodizing, electrophoresis, or painting on metal housings. A multiple-anodizing process may be used to achieve a pattern having a gradual color change. However, the multiple-anodizing process can be complicated.

Therefore, there is room for improvement within the art.

### BRIEF DESCRIPTION OF THE DRAWINGS

Many aspects of the housing for electronic device and method for making the housing can be better understood with reference to the following drawings. The components in the drawings are not necessarily to scale, the emphasis instead being placed upon clearly illustrating the principles of the present housing and method for making the housing.

FIG. 1 is a cross-sectional view of an exemplary embodiment of the present housing.

FIG. 2 is a cross-sectional view of a second embodiment of the present housing.

FIG. 3 is a cross-sectional view of a third embodiment of the present housing.

FIG. 4 is a cross-sectional view of a fourth embodiment of the present housing.

### DETAILED DESCRIPTION

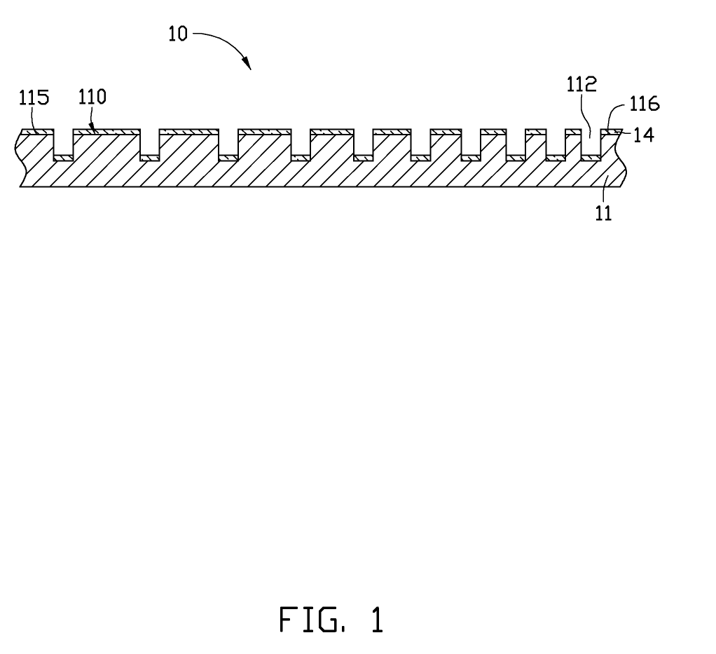

FIG. 1 shows an exemplary embodiment of a housing 10 for an electronic device such as a mobile phone. The housing 10 includes a substrate 11 and a protective layer 14 formed on the substrate 11. The substrate 11 is made of metal, such as stainless steel, titanium, titanium alloy, aluminum alloy, and magnesium alloy.

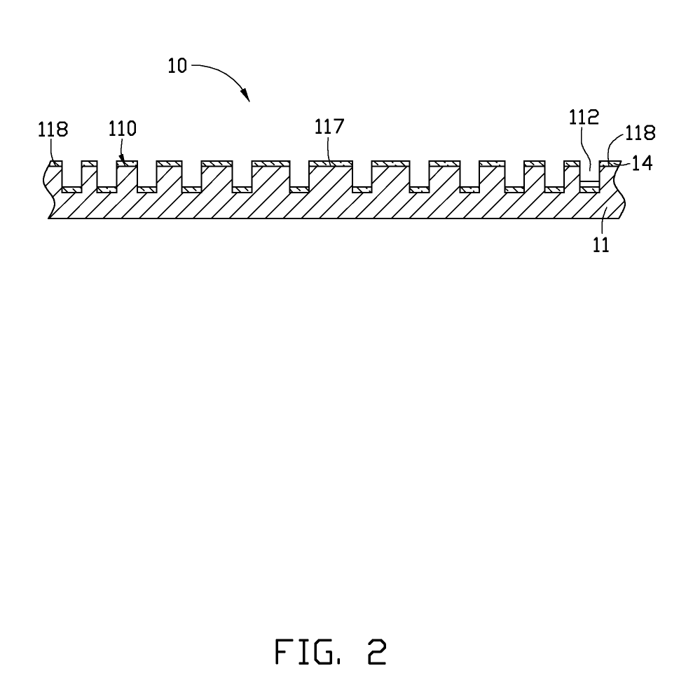

The substrate 11 has a plurality of recesses 112 formed on an outer surface 110 thereof. The recesses 112 may have an average width of about 0.02 mm-0.04 mm. The average depth of the recesses 112 may be about 0.05 mm-0.1 mm. The distance between each two adjacent recesses 112 may be about 0.2 mm-2 mm. The distance between each two adjacent recesses 112 can gradually change (increase or decrease) from a first end 115 of the outer surface 110 to a second end 116 opposite to the first end 115 of the outer surface 110. However, even with the change in distance between each two adjacent recesses 112, the distance between each two adjacent recesses 112 may be about 0.2 mm-2 mm. Referring to FIG. 2, in a second embodiment, the distance between each two adjacent recesses 112 can gradually change (increase or decrease) from a center 117 of the outer surface 110 to at least one periphery 118 of the outer surface 110. However, even with the change in distance between each two adjacent recesses 112, the distance between each two adjacent recesses 112 may be about 0.2 mm-2 mm. That is, the recesses 112 are dispersed or distributed on the outer surface 110 with a dispersing gradual change of density, from thin to thick or from thick to thin. Thereby, the recesses 112 cooperatively form a reflective pattern having a gradual color change on the housing 100. The higher the density the darker the color of the corresponding area is.

The protective layer 14 may be a transparent polyurethane layer. The thickness of the protective layer 14 may be about 20 μm-30 μm. The protective layer 14 protects the outer surface 110 from damage.

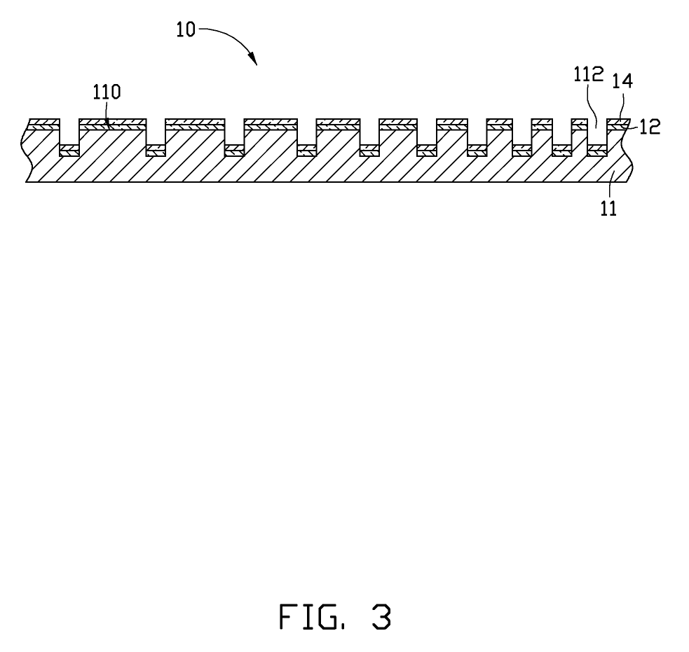

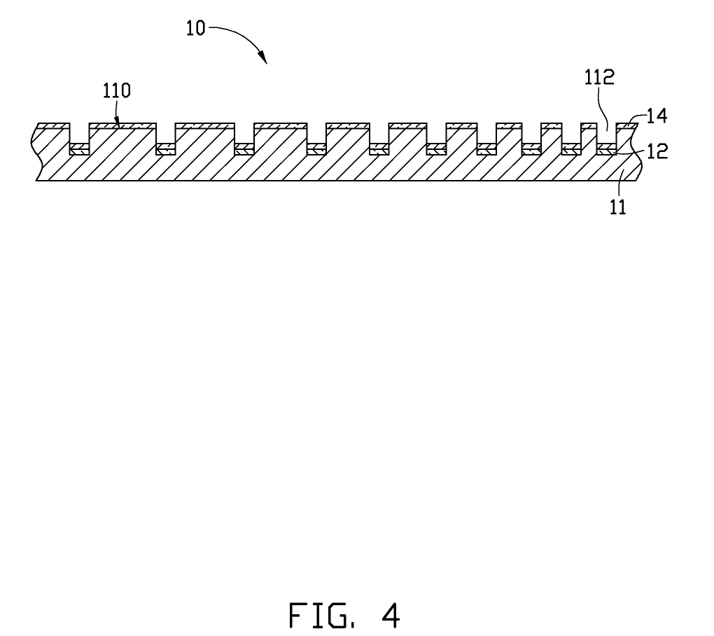

Referring to FIG. 3, the housing 10 may further include a color layer 12 between the substrate 11 and the protective layer 14. The color layer 12 may be a paint color layer, an ink color layer, or a vacuum coated layer, thereby to present a desirable color to the outer surface 110. The color layer 12 may be coated on the entire outer surface 110. In other embodiments, the color layer 12 may be coated only in the recesses 112, as shown in FIG. 4. To ensure a good visibility of the pattern, the color layer 12 preferably has a light color and has a degree of transparency.

An exemplary method for making the housing 10 may include the following steps.

The substrate 11 having the outer surface 110 is provided. The substrate 11 may be made of metal, such as stainless steel, titanium, titanium alloy, aluminum alloy, and magnesium alloy. The substrate 11 may be formed by punching.

A plurality of recesses 112 are formed by laser engraving. A laser engraving machine (not shown) may be used. The operation of the laser engraving machine is numerically controlled. A pattern is first converted into digital data, then the laser engraving machine engraves the outer surface 110 of the substrate 11 in accordance with the digital data to produce the recesses 112. The pattern is defined by the combination of the recesses 112. The recesses 112 may have an average width of about 0.02 mm-0.04 mm. The average depth of the recesses 112 may be about 0.05 mm-0.1 mm. The distance between each two adjacent recesses 112 may be about 0.2 mm-2 mm, and the recesses 112 are dispersed on the outer surface 110 with a dispersing gradual change of density as described above.

The laser engraving process may be carried out under the following parameters: a frequency of about 1000 Hz-30000 Hz, a power of about 5 W-20 W, a scanning rate of about 200 mm/s-500 mm/s, a scanning energy of about 0.2 millijoules (mJ)-2 mJ, and a focused diameter of a laser beam of about 0.02 mm-0.04 mm.

The protective layer 14 is formed on the substrate 11 such as by spray painting. The protective layer 14 may have a thickness of about 20 μm-30 μm.

The method for making the housing 10 may further include forming a color layer 12 between the substrate 11 and the protective layer 14, before forming the protective layer 14. The color layer 12 may be formed by spray painting, ink printing, or vacuum deposition. The color layer 12 may be coated on the entire outer surface 110. Alternatively, the color layer 12 may be coated only in the recesses 112.

It should be understood that the protective layer 14 may be omitted, thus the step of forming the protective layer 14 may be omitted.

It is believed that the exemplary embodiment and its advantages will be understood from the foregoing description, and it will be apparent that various changes may be made thereto without departing from the spirit and scope of the disclosure or sacrificing all of its advantages, the examples hereinbefore described merely being preferred or exemplary embodiment of the disclosure.

What is claimed is:

1. A housing for an electronic device, comprising:
a substrate, the substrate having an outer surface; and
a plurality of recesses formed on the outer surface of the substrate, the recesses defining a pattern, the recesses being distributed on the outer surface with a gradual change of density of the recesses across at least one dimension of the outer surface, the recesses having an average width of about 0.02 mm-0.04 mm, the average depth of the recesses being about 0.05 mm-0.1 mm, the distance between each two adjacent recesses being about 0.2 mm-2 mm.

2. The housing as claimed in claim 1, wherein the outer surface has a first end and a second opposite to the first end, the distance between each two adjacent recesses gradually increasing or decreasing from the first end to the second end.

3. The housing as claimed in claim 1, wherein the distance between each two adjacent recesses gradually changes from a center of the outer surface to at least one periphery of the outer surface.

4. The housing as claimed in claim 1, further comprising a protective layer formed on the outer surface.

5. The housing as claimed in claim 4, wherein the protective layer is a transparent polyurethane layer.

6. The housing as claimed in claim 1, further comprising a color layer formed between the substrate and the protective layer.

7. The housing as claimed in claim 6, wherein the color layer is one selected from the group consisting of a paint color layer, an ink color layer, and a vacuum coated layer.

8. The housing as claimed in claim 7, wherein the color layer is at least partially transparent.

9. The housing as claimed in claim 6, wherein the color layer is coated on the entire outer surface.

10. The housing as claimed in claim 6, wherein the color layer is coated only in the recesses.

11. The housing as claimed in claim 1, wherein the substrate is made of metal.

12. A method for making a housing for an electronic device, comprising the steps of:
providing a metal substrate, the metal substrate having an outer surface;
forming a plurality of recesses on the outer surface of the metal substrate by laser engraving, the recesses defining a pattern, the recesses being distributed on the outer surface with a gradual change of density of recesses across at least one dimension of the outer surface, the recesses having an average width of about 0.02 mm-0.04 mm, the average depth of the recesses being about 0.05 mm-0.1 mm, the distance between each two adjacent recesses being about 0.2 mm-2 mm.

13. The method as claimed in claim 12, wherein laser engraving the recesses uses a laser engraving machine under the following parameters: a frequency of about 1000 Hz-30000 Hz, a power of about 5 W-20 W, a scanning rate of about 200 mm/s-500 mm/s, a scanning energy of about 0.2 mJ-2 mJ, and a focused diameter of a laser beam of about 0.02 mm-0.04 mm.

14. The method as claimed in claim 12, further comprising a step of forming a color layer on the outer surface, after the laser engraving step.

15. The method as claimed in claim 14, wherein the color layer is formed by one method selected from the group consisting of spray painting, ink printing, and vacuum deposition.

16. The method as claimed in claim 15, further comprising a step of forming a protective layer on the color layer, after the step of forming the color layer.

17. The method as claimed in claim 16, wherein the protective layer is formed by spray painting.
